(19) United States
(12) Patent Application Publication
(10) Pub. No.: US 2012/0290110 A1
(43) Pub. Date: Nov. 15, 2012

(54) Evaluating Composite Applications Through Graphical Modeling

(75) Inventors: Eitan Hadar, Nesher (IL); Donald F. Ferguson, South Salem, NY (US); Vincent R. Re, Saint James, NY (US); John P. Kane, Tafton, PA (US); Brian J. Hughes, Round Hill, VA (US)

(73) Assignee: Computer Associates Think, Inc., Islandia, NY (US)

(21) Appl. No.: 13/107,233

(22) Filed: May 13, 2011

(51) Int. Cl. G06F 19/00

(52) U.S. Cl. 700/92

(57) ABSTRACT

According to one embodiment of the present disclosure, a method for evaluating composite applications through graphical modeling may be provided. The method may include displaying one or more characteristic objects that are graphically associated with a first entity object. An indication of a score calculation methodology of the first entity object and an indication of a score calculation methodology of each characteristic object may be received. A score of each characteristic object may be determined. Each score may be based on at least one or more measurements of a measured object that is graphically associated with the first entity object and the score calculation methodology of the respective characteristic object. A score of the first entity object may be determined and displayed, the determination based on at least each score of the one or more characteristic objects and the score calculation methodology of the first entity object.

### TECHNICAL FIELD

This invention relates generally to the field of information technology and more specifically to evaluating composite applications through graphical modeling.

### BACKGROUND

Organizations often use various information technology services to support their operations. As an example, an organization may use one or more composite applications, that is, one or more end-to-end solutions that implement one or more business services. An organization must decide how much of these information technology services to provide by itself and how much to outsource to a third party. If the organization decides to outsource a service, it often must choose from among several service providers. Various factors may be important to the organization as it chooses its service providers.

### SUMMARY OF THE DISCLOSURE

According to one embodiment of the present disclosure, a method for evaluating composite applications through graphical modeling may be provided. The method may include displaying one or more characteristic objects that are graphically associated with a first entity object. An indication of a score calculation methodology of the first entity object and an indication of a score calculation methodology of each characteristic object may be received. A score of each characteristic object may be determined. Each of these scores may be based on 1) at least one or more measurements of a measured object that is graphically associated with the first entity object, and 2) the score calculation methodology of the respective characteristic object. A score of the first entity object may be determined and displayed, the determination based on at least each score of the one or more characteristic objects and the score calculation methodology of the first entity object.

Certain embodiments of the disclosure may provide one or more technical advantages. A technical advantage of one embodiment may be that a composite application may be evaluated using a graphical modeling tool. Another technical advantage of one embodiment may be that a score calculation methodology of a composite application may be constructed, viewed, edited, and/or reused through a graphical modeling tool.

Certain embodiments of the disclosure may include none, some, or all of the above technical advantages. One or more other technical advantages may be readily apparent to one skilled in the art from the figures, descriptions, and claims included herein.

### BRIEF DESCRIPTION OF THE DRAWINGS

For a more complete understanding of the present disclosure and its features and advantages, reference is now made to the following description, taken in conjunction with the accompanying drawings, in which:

FIG. 1A depicts an example of a system for evaluating composite applications through graphical modeling;

FIG. 1B depicts an example method that may be performed by the system of FIG. 1A;

FIG. 2 depicts an example of a graphical modeling tool for evaluating composite applications through graphical modeling;

FIG. 3 depicts an example graphical model that can be implemented by the system of FIG. 1A; and

FIG. 4 depicts another example graphical model that can be implemented by the system of FIG. 1A.

### DETAILED DESCRIPTION OF THE DRAWINGS

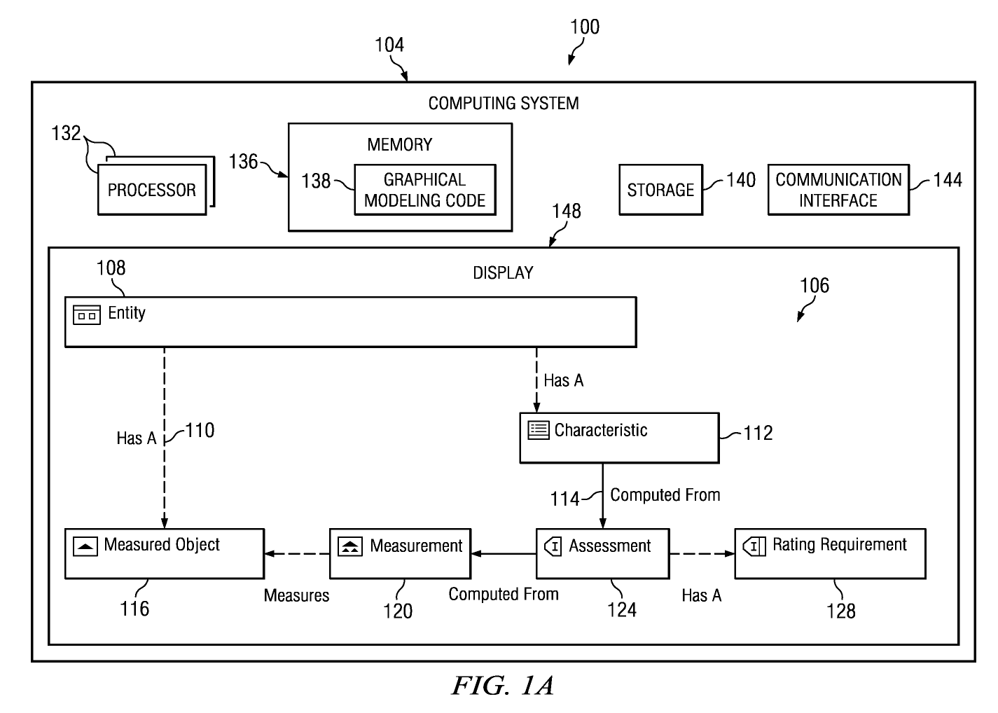

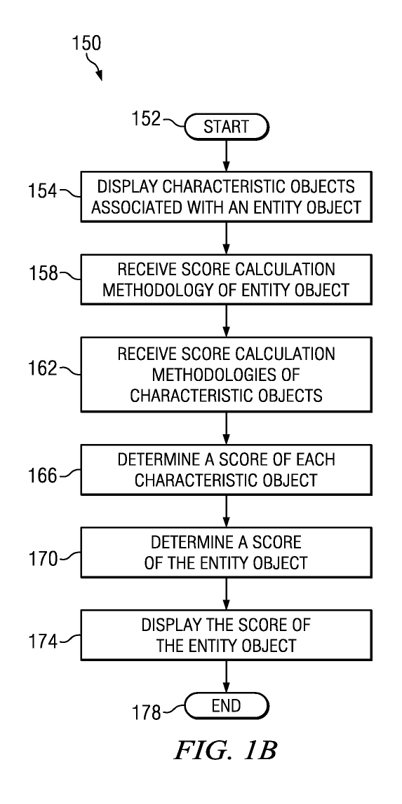

Embodiments of the present disclosure and its advantages are best understood by referring to FIGS. 1-4 of the drawings, like numerals being used for like and corresponding parts of the various drawings.

FIG. 1A depicts an example of a system 100 for evaluating composite applications through graphical modeling. System 100 may comprise a computing system 104. Computing system 104 includes one or more processors 132, memory 136, storage 140, communication interface 144, and display 148. Computing system 104 is operable to display on display 148 one or more characteristic objects 112 graphically associated with a first entity object 108. Each characteristic object 112 may correspond to at least one characteristic of an entity corresponding to first entity object 108. System 100 may receive an indication of a score calculation methodology of first entity object 108 and an indication of a score calculation methodology of each characteristic object 112. Computing system 104 may determine a score of each characteristic object. Each score of a respective characteristic object 112 may be based on at least one or more measurements of a measured object 116 that is graphically associated with first entity object 108 and the score calculation methodology of the respective characteristic object 112. Computing system 104 may determine a score of first entity object 108 based on at least each score of the one or more characteristic objects 112 and the score calculation methodology of the first entity object 108. The score of first entity object 108 may then be provided to a user via display 148.

System 100 may allow a user to build a graphical model 106 of a composite application. A composite application is an information technology (IT) solution that implements one or more services, such as a business service. A composite application may utilize hardware, software, applications, data, networks, and/or other elements. The graphical model may include the composite application and one or more of its elements graphically associated with each other. Graphical associations will be discussed in more depth below.

System 100 may enable a user to evaluate the quality of the composite application by graphically associating characteristics with the composite application or an element thereof and producing a score for each characteristic. These scores may be used to calculate a score for the composite application. In some embodiments, the score calculation methodology of the characteristics and/or composite application may be displayed along with the graphical association of the elements of the composite application.

System 100 may allow the user to rate different implementations of a composite application according to the user's preferences. As an example, a user may indicate which characteristics are most important to the user, and system 100 may take those preferences into account in calculating a scope of a particular implementation of a composite application. As another example, a user may swap different services and/or hardware into the composite application and reevaluate the model. Thus, system 100 may aid a user in deciding whether to outsource a particular IT service or provide the service in-house. The system may also aid the user in comparing solutions from various vendors.

In the embodiment depicted in FIG. 1A, system 100 includes a computing system 104. Computing system 104 may be any suitable combination of hardware and/or software that enables the evaluation of composite applications through graphical modeling. Computing system 104 may include one or more portions of one or more computer systems. In particular embodiments, one or more of these computer systems may perform one or more steps of one or more methods described or illustrated herein. In particular embodiments, one or more computer systems may provide functionality described or illustrated herein. In some embodiments, encoded software running on one or more computer systems may perform one or more steps of one or more methods described or illustrated herein and/or provide functionality described or illustrated herein.

The components of one or more computer systems may comprise any suitable physical form, configuration, number, type, and/or layout. As an example, and not by way of limitation, one or more computer systems may comprise an embedded computer system, a system-on-chip (SOC), a single-board computer system (SBC) (such as, for example, a computer-on-module (COM) or a system-on-module (SOM)), a desktop computer system, a laptop or notebook computer system, an interactive kiosk, a mainframe, a mesh of computer systems, a mobile telephone, a personal digital assistant (PDA), a server, or a combination of two or more of these. Where appropriate, one or more computer systems may be unitary or distributed, span multiple locations, span multiple machines, or reside in a cloud, which may include one or more cloud components in one or more networks.

Where appropriate, one or more computer systems may perform without substantial spatial or temporal limitation one or more steps of one or more methods described or illustrated herein. As an example, and not by way of limitation, one or more computer systems may perform in real time or in batch mode one or more steps of one or more methods described or illustrated herein. One or more computer systems may perform at different times or at different locations one or more steps of one or more methods described or illustrated herein, where appropriate.

In particular embodiments, a computer system may include a processor, memory, storage, a communication interface, and a display. As an example, computing system 104 comprises a computer system that includes one or more processors 132, memory 136, storage 140, communication interface 144, and display 148. These components may work together in order to provide functionality described herein.

A processor 132 may be a microprocessor, controller, or any other suitable computing device, resource, or combination of hardware, stored software and/or encoded logic operable to provide, either alone or in conjunction with other components of computing system 104, computing system functionality. In some embodiments, computing system 104 may utilize multiple processors to perform the functions described herein.

Memory 136 and/or storage 140 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 136 and/or storage 140 may store any suitable data or information utilized by computing system 104, including software embedded in a computer readable medium, and/or encoded logic incorporated in hardware or otherwise stored (e.g., firmware). In some embodiments, memory 136 and/or storage 140 may store one or more entity objects 108, characteristic objects 112, measured objects 116, measurement objects 120, assessment objects 124, and/or rating requirement objects 128. Memory 136 and/or storage 140 may also store the results and/or intermediate results of the various calculations and determinations performed by processor 132.

In particular embodiments, the operations of the embodiments may be performed by one or more computer readable media (such as graphical modeling code 138 of memory 136) encoded with a computer program, software, computer executable instructions, and/or instructions capable of being executed by a computing system. In particular embodiments, the operations of the embodiments may be performed by one or more computer readable media storing, embodied with, and/or encoded with a computer program and/or having a stored and/or an encoded computer program.

Communication interface 144 may be used for the communication of signaling and/or data between computing system 104 and one or more networks and/or components coupled to a network. Display 148 may be used to facilitate interaction between computing system 104 and one or more users. Display 148 may comprise any device or combination of devices capable of providing a visual representation of data of computing system 104. As an example, display 148 may be a computer monitor or other screen.

In some embodiments, system 100 may include one or more entity objects 108 displayed by computing system 104 on display 148. An entity object may be a logical representation of a corresponding entity. An entity may be one or more components and/or processes in an information technology (IT) environment. For example, an entity may be an abstract entity, a composite application, a service, a software component, or a computer system. In some embodiments, system 100 may comprise entity objects that correspond to one or more of these entities. Thus, entity objects of system 100 may include abstract entity objects, composite application objects, service objects, software component objects, and computer system objects.

An abstract entity object may correspond to an abstract element of an IT environment. For example, an abstract entity object may correspond to a user defined element or group of elements, such as an entire business organization.

A composite application object may correspond to a composite application. A composite application is an IT solution that implements one or more services, such as a business service. A composite application may utilize hardware, software, applications, data, networks, and/or other elements of an IT environment.

A service object may correspond to a service provided to one or more users by a service provider. A service may utilize information technology and, in some embodiments, may support a user's business processes. A service may be made up of a combination of people, processes, technology, other services, or supporting components.

A software component object may correspond to a software component, such as a logical software entity that implements a functional behavior. A software component may be a collection of files installed and run on a computing system or other hardware component. A software component may implement the behavior of a service.

A computer system object may correspond to a computer system or a portion thereof, such as a server, mainframe, personal computing device, other system capable of hosting a software component, an element of computer hardware, a protocol implemented by a computing system, or other suitable computer system or component thereof.

In some embodiments, an entity object may have one or more attributes. For example, an entity object may have a name, description, and/or additional documentation expressed as string values. In some embodiments, these attributes may be searchable.

As another example of an attribute, an entity object 108 may have a score that represents the quality of the corresponding entity. A score of an entity object may be expressed in any suitable manner. In some embodiments, scores may be expressed as percentages or other numerical or alphabetical indications.

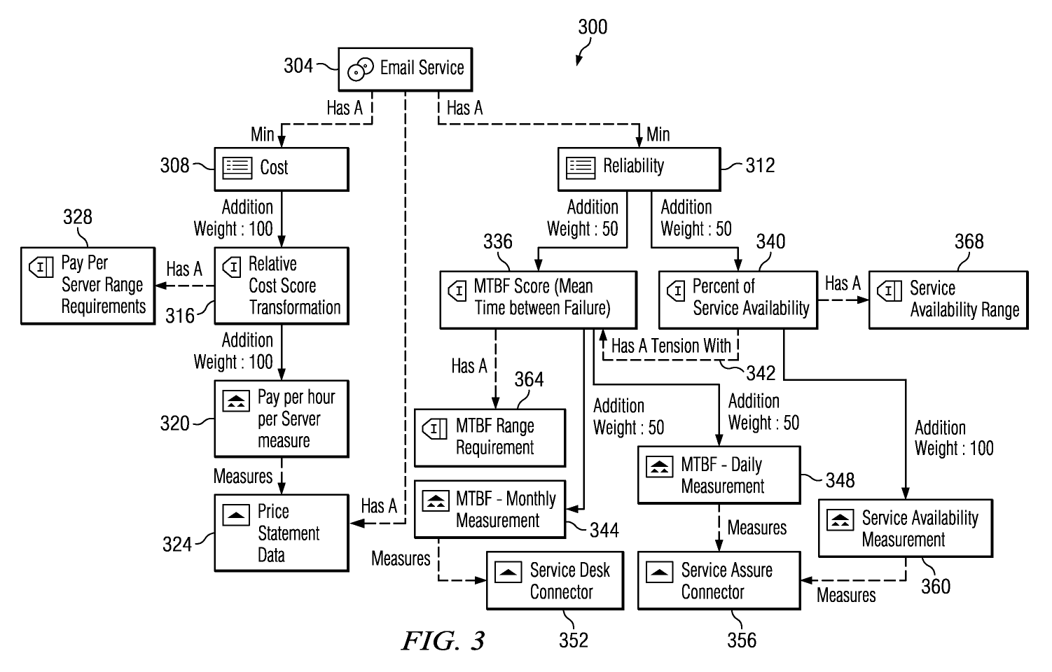

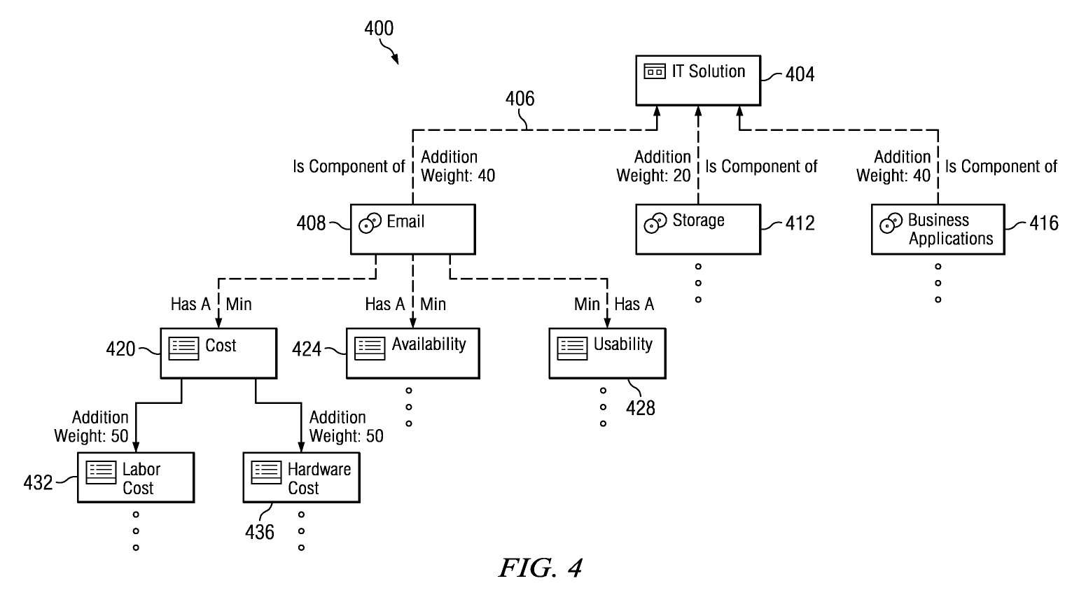

As another example of an attribute, an entity object 108 may have a score calculation methodology (illustrated in FIGS. 3 and 4 discussed below). The score calculation methodology may include any suitable algorithm for calculating the score of the entity object. In some embodiments, the score calculation methodology may be based on any suitable criteria, such as one or more attributes (e.g., scores) of characteristic objects 112 (described in more detail below) and/or one or more attributes (e.g., scores) of other entity objects associated with the entity object. For example, a weight (i.e., preference) may be specified for each characteristic object and/or other entity object associated with the entity object. The weight values may indicate one or more preferences of the user for certain characteristics and/or entities. In some situations, the reliability of an entity may be more important than the cost of an entity, and the objects corresponding to these characteristics may be weighted accordingly. The various weights may be combined with one or more other indications (e.g., operations) to compute the score of the entity object. As an example, a weight of each characteristic object (and/or other entity object) may be multiplied by a score of the respective characteristic object (or other entity object) and an operation (such as a sum, product, average, max, min, or other operation) may be performed on the weighted values to generate the score of the entity object.

In some embodiments, a score calculation methodology (or a portion thereof) of an entity object 108 may be displayed along with the structure (i.e., objects and connectors) of the graphical model. As an example, a weight and an operation may be displayed for each characteristic object 112 (or other entity object) associated with an entity object. In some embodiments, a user may indicate the score calculation methodology. Therefore, a user may easily recognize and/or adjust the score calculation methodology based on its visual representation.

FIG. 1B depicts an example method 150 that may be performed by the system of FIG. 1A. In some embodiments, various steps depicted in FIG. 1B may be performed by executing graphical modeling code 138 by one or more processors 132 of FIG. 1A.

The method begins at step 152. At step 154, one or more characteristic objects 112 associated with an entity object 108 are displayed by computing system 104. The collective objects may be displayed on display 148. The characteristic objects may be graphically associated (described in more detail below) with the entity object.

At step 158, a score calculation methodology of entity object 108 may be received by computing system 104. In some embodiments, a user may interact with computing system 104 to specify the score calculation methodology. In some embodiments, the score calculation methodology may be displayed in relation to the entity object 108 and the one or more characteristic objects 112. As described above, any suitable algorithm may be used as a score calculation methodology. The remaining steps of FIG. 1B are described below.

Referring back to FIG. 1A, system 100 may also include one or more characteristic objects 112 displayed by computing system 104 on display 148. Each characteristic object 112 may be associated (e.g., graphically) with an entity object 108 and may correspond to at least one characteristic of the entity corresponding to the associated entity object. A characteristic may be a functional or non-functional description of one or more properties of the entity. Examples of characteristics may include quality, agility, risk, cost, capability, security, usability, testability, maintainability, extensibility, scalability, portability, interoperability, and availability. In some embodiments, a characteristic may be defined by one or more secondary characteristics. Accordingly, a characteristic object may be associated with one or more secondary characteristic objects (as illustrated by objects 420, 432, and 436 of FIG. 4). As an example, a characteristic object corresponding to availability may be associated (e.g., graphically) with secondary characteristic objects respectively corresponding to reliability, maintainability, serviceability, performance, and security.

In some embodiments, a user may select one or more characteristic objects 112 to associate with an entity object 108. In some situations, various characteristics of a composite application (or other entity) may be important to a particular user. Accordingly, the user may associate corresponding characteristic objects with a composite application object. Each characteristic may be evaluated (e.g., according to a user defined methodology) and a score for the corresponding characteristic 112 object may be generated. In some embodiments, a user may indicate that one or more of the characteristics are more important than others. The composite application (or other entity associated with the characteristics) may be evaluated according to these preferences and the scores of the characteristic objects 112. Such evaluations may enable to a user to assess the strengths and weaknesses of a composite application (or other entity) and to compare various implementations of the composite application (or other entity).

In some embodiments, a characteristic object may have one or more attributes. For example, a characteristic object may have a name, description, and/or additional documentation expressed as string values. In some embodiments, these attributes may be searchable.

As another example of an attribute, a characteristic object 112 may have a score that represents the strength of the corresponding characteristic of the associated entity. A score attribute of a characteristic object may be expressed in any suitable manner. For example, the score of a characteristic object may be expressed as a percentage or other numerical or alphabetical indication.

As another example of an attribute, a characteristic object 112 may have a score calculation methodology (illustrated in FIGS. 3 and 4 discussed below). The score calculation methodology may include any suitable algorithm for calculating the score of the characteristic object. In some embodiments, the score calculation methodology may be based on any suitable criteria, such as one or more attributes (e.g., assessment scores) of assessment objects 124 (described in more detail below) and/or one or more attributes (e.g., scores) of secondary characteristic objects associated with the characteristic object. As explained in further detail below, an assessment score may be based on one or more measurements of a measured object 116. Thus, the score of the characteristic object may be based (at least partially) on one or more measurements of the measured object.

In some embodiments, a score calculation methodology of a characteristic object 112 may include a weight of each associated assessment object 124 and/or secondary characteristic object. The weight values may indicate one or more preferences of the user for certain assessments and/or secondary characteristics. The various weights may be combined with one or more other indications (e.g., operations) to compute the score of the characteristic object 112. As an example, a weight of each assessment object (or secondary characteristic object) may be multiplied by an assessment score of the respective assessment object (or score of the secondary characteristic object) and an operation (such as a sum, product, average, max, min, or other operation) may be performed on the weighted values to generate the score of the characteristic object.

In some embodiments, a score calculation methodology (or a portion thereof) of a characteristic object 112 may be displayed along with the structure (i.e., objects and connectors) of the graphical model (as shown in FIGS. 3 and 4 discussed below). As an example, a weight and an operation may be displayed for each assessment object 124 (and/or secondary characteristic object) associated with a characteristic object. In some embodiments, a user may indicate the score calculation methodology. Therefore, a user may easily recognize and/or adjust the score calculation methodology based on its visual representation.

Referring back to FIG. 1B, in addition to receiving a score calculation of entity object 108 at step 158, computing system 104 may also receive a score calculation methodology of each characteristic object 112 at step 162. In some embodiments, a user may interact with computing system 104 to specify the score calculation methodologies of the characteristic objects 112. In some embodiments, the score calculation methodologies may be displayed in relation to their respective characteristic objects 112. As described above, any suitable algorithm may be used as a score calculation methodology.

At step 166, a score of each characteristic object 112 is determined. The score of each characteristic object 112 may be based on the score calculation methodology of the respective characteristic object and one or more measurements of a measured object 116 that is graphically associated with the first entity object 108.

At step 170, a score of the entity object 108 is determined. The score of the entity object may be based on each score of the characteristic objects 112 and the score calculation methodology of the entity object 108. At step 174, the score of the entity object is displayed. The score may be displayed on display 148. The method ends at step 178.

Referring again to FIG. 1A, a characteristic object 112 may also have a computed value type attribute that describes the type of the characteristic object's score attribute. The type of the score attribute may be any suitable type, such as percentage, count, ratio, Boolean, or other type.

As another example of an attribute, a characteristic object 112 may have a quality status attribute. The quality status attribute may indicate whether or not the requirements for all of the assessment objects 124 and/or secondary characteristic objects associated with the characteristic object are met. As an example, the assessment objects and/or secondary characteristic objects may be associated with a service level agreement or other set of requirements. In some embodiments, if any of these requirements are not met, the quality status value may be set to false. Thus, a quality status value of true may represent a healthy system as to the relevant characteristic. In other embodiments, the quality status may be a numerical or alphabetical indicator of a level of compliance with the relevant requirements.

A characteristic object 112 may be graphically associated with one or more assessment objects 124. An assessment object may define a method for aggregating measurements and/or other data in order to compute one or more values that can be compared with one or more values of one or more rating requirement objects 128 associated (e.g., graphically) with the assessment object. In some embodiments, an assessment object may also be associated (e.g., graphically) with one or more measurement objects 120.

In some embodiments, an assessment object 124 may have various attributes. For example, an assessment object may have one or more computed values. A computed value may be one or more accumulated or computed values based on data from one or more measured objects 116 (which may be received directly or via an associated measurement object 120).

As another example of an attribute, an assessment object 124 may include one or more assessment scores. An assessment score may indicate an assessment of the associated characteristic based on a comparison between one or more computed values of the assessment object and one or more values specified by a rating requirement object 128. In some embodiments, an assessment object may be associated with multiple rating requirement objects and may generate an assessment score for each rating requirement object.

An assessment score may be determined in any suitable manner and may be based on objective data (e.g., computer measurements) and/or subjective data (e.g., user experience feedback). As an example, an assessment score may be based on a difference distance (e.g., normalized value of a difference) or ratio between one or more computed values of the assessment object 124 and one or more values specified by one or more rating requirement objects 128. In some embodiments, the values of a rating requirement object may be based on a service level agreement, a community recognized standard, or other suitable metric. In some embodiments, values of a rating requirement object may include a rating range lower limit and a rating range upper limit (explained below). In some embodiments, the assessment scores of the assessment object may be computed as follows:

$${AssessmentScore}_{i} = \{ \begin{matrix}100.0 & if ACV \geq {RRU}_{i} \\ \frac{( ACV - {RRL}_{i} )}{( {RRU}_{i} - {RRL}_{i} )} & if {RRU}_{i} > ACV > {RRL}_{i} \\ 0.0 & if ACV \leq {RRL}_{i}\end{matrix} \}$$

Where i is the relevant rating requirement object, ACV is a computed value of the assessment object, RRL is the rating range lower limit of the relevant rating requirement object, and RRU is the rating range upper limit of the relevant rating requirement object.

In some embodiments, an assessment object 124 may calculate an assessment score without using a rating requirement object 128. For example, an assessment object may manipulate a computed value (e.g., multiply the computed value by a weight) to generate the assessment score or use the computed value as the assessment score.

In some embodiments, an assessment object 124 may have a legal reliability attribute. A legal reliability is a value that indicates a reliability of a source of information used to generate a computed value. For example, a source may be more reliable if it uses automated information gathering techniques as opposed to human generated information. In some embodiments, a legal reliability may be expressed as a Boolean where “true” represents reliable information. In some embodiments, legal reliability may be expressed as a number on a sliding scale of reliability.

In some embodiments, an assessment object 124 may be associated (e.g., graphically) with one or more measurement objects 120. A measurement object may also be associated (e.g., graphically) with one or more measured objects 116. A measurement object 120 may collect information to help manage a process or service. A measurement object may aggregate data (e.g., from one or more measured objects 116) for use by an assessment object 124. In some embodiments, measurements obtained by measurement objects are non-negative and additive such that the measurements of two non-overlapping sets equals the sum of their individual measurements. In some embodiments, measurements may be either metrics or indicators.

In some embodiments, a measurement object 120 may have various attributes. As an example, a measurement object may have a measured value attribute. A measured value of a measurement object is a result based on data accessed at a measured object 116. In some embodiments, the measured value may include the original data acquired from a measured object. In some embodiments, a measurement object may manipulate data from one or more measured objects to calculate a measured value.

As another example of an attribute, a measurement object 120 may have a margin of error attribute. The margin of error may represent a margin of error for a measured value. As another example, a measurement object may have a confidence level attribute. A confidence level may be the probability that the actual property of the physical object measured by the measured object 116 is within a margin of error of the measurement object.

As another example of an attribute, a measurement object may also include a type of measurement attribute. The type of measurement may specify how a measurement is obtained and may aid in computing the legal reliability of an assessment object 124. In some embodiments, a type of measurement may have any suitable value, such as automated or manual.

In some embodiments, a measurement object 120 may be associated (e.g., graphically) with one or more measured objects 116. A measured object may also be associated (e.g., graphically) with an entity object 108. A measured object may measure and/or supply data relating to an information technology environment or a portion thereof. For example, a measured object may provide data relating to cost, reliability, speed, or other performance characteristic of a component or service. Such data may include data from any suitable source, such as a monitoring tool, a price sheet, a data base, or other suitable source. A measured object may be operable to provide this data to one or more measurement objects.

In some embodiments, a rating requirement object 128 may be associated (e.g., graphically) with an assessment object 124. A rating requirement object may define one or more values that may be compared to one or more computed values of an assessment object in order to assess the quality of a particular characteristic object 112. As an example, a rating requirement object may comprise a range of acceptable values that are compared to one or more computed values of an assessment object.

In some embodiments, a rating requirement object 128 may have various attributes. As an example, a rating requirement object may have one or more threshold settings. As an example, a rating requirement object may have a rating range upper limit setting and/or a rating range lower limit setting. As an example, a threshold setting may define a requirement such as a requirement of a service level agreement. Examples of threshold settings include four hours to solve a particular incident, five soft disk errors in an hour, 10 failed changes in a month, or availability of 99.5% to 99.9%.

As another example of an attribute, a rating requirement object may have a sensitivity level type. A sensitivity level type represents the granularity of values that may be compared against threshold settings. In some embodiments, a sensitivity level type may be a percentage level such as a step for every three percent, or an integer level, such as a step for every five increments. In other embodiments, a sensitivity level type may be a Boolean or a selection.

In some embodiments, one or more objects (such as objects 108, 112, 116, 120, 124, and 128) may be graphically associated with one or more other objects. For example, an entity object 108 may be graphically associated with one or more other entity objects. Thus, to model a composite application, a composite application object of system 100 may be graphically associated with one or more abstract entity objects, other composite application objects, service objects, software component objects, and/or computer system objects. Similarly, to model a service, a service object of system 100 may be graphically associated with one or more abstract entities, composite application objects, other service objects, software component objects, and/or computer system objects.

A graphical association is an association that is visually recognizable. Graphical associations may be indicated in any suitable manner. For example, one or more displayable properties of an object may indicate that the object is associated with another object. As another example, an object may be connected to another object by a connector (or through a series of connectors that connect intervening objects). In some embodiments, a connector between objects may also include a description of the relationship between the objects.

As an example of a connector, objects may be connected by a “has a” connector 110. A “has a” connector may be used to convey ownership. In some embodiments, a “has a” connector may be used to connect a characteristic object 112 to an entity object 108 or a rating requirement object 128 to an assessment object 124.

As another example of a connector, an object may be connected to another object by an “is component of” connector (such as connector 406 of FIG. 4). In some embodiments, an entity object 108 may be connected to another entity object by an “is component of” connector. For example, if a composite application includes various services, software components, and/or hardware components, a corresponding composite application object may be connected to one or more service objects, software component objects, and/or computer system objects by one or more “is component of” connectors.

As another example of a connector, two objects may be connected by an “is hosted by” connector (not shown). This connector indicates that software corresponding to a software component object is hosted by a computer system that corresponds to a connected computer system object.

As another example of a connector, two or more objects may be connected by a “computed from” connector 114. In some embodiments, a characteristic object 112 may be connected to one or more secondary characteristic objects and/or assessment objects 124 with a “computed from” connector. This connector indicates that the score of the characteristic object is computed from the scores of the one or more secondary characteristic objects and/or the scores of the assessment objects. In certain embodiments, an assessment object 124 may be connected to a measurement object 120 by a “computed from” connector. This signifies that a computed value of the assessment object is computed from one or more measured values of the measurement object.

As another example of a connector, an assessment object may be connected to another assessment object by a “has a tension with” connector (such as connector 342 of FIG. 3). A “has a tension with” connector signifies that an object affects and/or is affected by the connected object. This may alert a user that a deeper evaluation may be helpful when examining a single assessment object. A “has a tension with” connector may be any suitable value such as constructing, supporting, destructing or degrading.

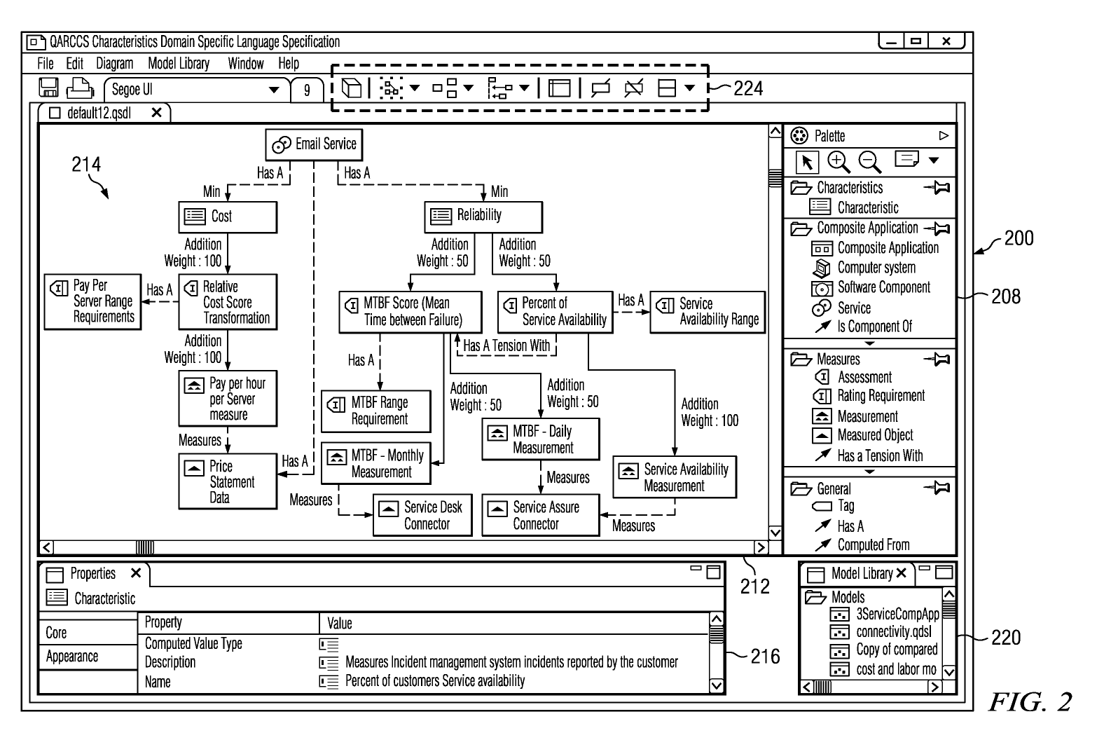

FIG. 2 depicts an example of a graphical modeling tool 200 for evaluating composite applications through graphical modeling. Graphical modeling tool 200 may be implemented by executing graphical modeling code 138 by processor 132. Graphical modeling tool 200 may produce an output that is shown on display 148 to provide an interface for a user to create a graphical model 214 of a composite application or other entity.

Graphical modeling tool 200 may comprise one or more sections, such as panes or windows. In some embodiments, graphical model window 212 may include a graphical model 214. The graphical model may be created in any suitable manner. In some embodiments, graphical model 214 may be built by a user and/or loaded from a saved modeling module displayed in window 220.

In some embodiments, graphical modeling tool 200 may comprise a palette section 208 operable to display one or more objects and/or connectors. A user may select one or more objects and/or connectors from palette section 208 and the selections may be instantiated in graphical model window 212. Palette section 208 may provide various selectable objects such as entity objects, characteristic objects, assessment objects, measurement objects, measured objects, rating requirement objects, and/or connectors such as “is a component of,” “has a,” “has a tension with,” and/or “is computed from.” In some embodiments, a user may select an instantiated object or connector in graphical model window 212 and the properties of the selected object may be displayed in window 216.

Library window 220 of graphical modeling tool 200 may show saved modeling modules. Graphical modeling tool 200 may enable a user to construct a model of a composite application (or other entity) and review one or more scores associated with that composite application.

In some embodiments, graphical modeling tool 200 may be operable to enforce one or more constraints on the graphical model. As an example, graphical modeling tool may be operable to detect incorrect usage of an object and/or a connector. As another example, graphical modeling tool 200 may be operable to determine that an incorrect score calculation methodology has been entered. In some embodiments, upon detection of a constraint violation, graphical modeling tool 200 may prompt a user to fix one or more errors in the graphical model.

FIG. 3 depicts an example graphical model 300 that can be implemented by system 100. Graphical model 300 is graphical model 214 of FIG. 2 shown in greater detail. Graphical model 300 may be displayed by computing system 104 on display 148. Graphical model 300 includes an entity object 304 corresponding to an email service. Entity object 304 is graphically associated (through “has a” connectors) with two characteristic objects 308 and 312, respectively corresponding to a cost of the email service and a reliability of the email service. Entity object 304 is also graphically associated with measured object 324 through a “has a” connector and with measured objects 352 and 356 through a series of connectors with intervening objects.

Characteristic object 308 is also graphically associated with assessment object 316, measurement object 320, measured object 324, and rating requirement object 328. Assessment object 316 is operable to provide a score (e.g., a normalized or relative score) of the cost of the email service. Measurement object 320 may convert and/or aggregate data from measured object 324 into a form that is similar to one or more values specified by rating requirement object 328. As an example, measured object 324 may provide data regarding costs incurred in maintaining a group of servers that supply the email service corresponding to entity object 304. Measurement object 320 may be operable to convert the data received from measured object 324 into a value equal to the price per hour per server for this group of servers.

Assessment object 316 may receive this value, compare it to one or more values specified by requirement rating object 328, and generate an assessment score based on the comparison. The assessment score is passed to entity object 308 which uses it to calculate a score of the cost of the email service. This score will be used with the score of characteristic object 312 to determine a score of entity object 304.

Characteristic object 312 is graphically associated with two assessment objects 336 and 340, respectively corresponding to mean time between failure (MTBF) and percent of service availability. Assessment object 336 is graphically associated with (and receives data from) measurement objects 344 and 348, respectively corresponding to MTBF monthly and daily measurements. Measurement object 344 samples data from measured object 352 (corresponding to a service desk connector) and generates a MTBF monthly measurement. Measurement object 348 samples data from measured object 356 (corresponding to a service assure connector) and generates a MTBF daily measurement. These measurements are passed to assessment object 336 which compares these values (or one or more values derived therefrom) to one or more values specified by rating requirement object 364. Assessment object 336 then generates an assessment score which is passed to characteristic object 312.

Assessment object 340 is graphically associated with assessment object 336, rating requirement object 368, measurement object 360, and measured object 356. Assessment object 340 receives data from measurement object 360, corresponding to a service availability measurement. Measurement object 360 samples data from measured object 356 and generates a service availability measurement. This measurement is passed to assessment object 340 which compares this value (or one or more values derived therefrom) to one or more values specified by rating requirement object 368. Assessment object 340 then generates an assessment score which is passed to characteristic object 312.

Characteristic object 312 may use the assessment scores received from assessment objects 336 and 340 to calculate a score of the reliability of the email service. As specified in FIG. 3, each assessment score carries a weight of 50 percent. Thus, each score is weighted appropriately, and the weighted scores are added together to generate the score of characteristic object 312.

The scores of characteristic objects 308 and 312 are then used to calculate a score of entity object 304. As specified in FIG. 3, this score is calculated using a MIN operation. Accordingly, the score of entity object 304 is the minimum of the scores of the characteristic objects 308 and 312.

FIG. 4 depicts another example graphical model 400 that can be implemented by system 100. Graphical model 400 includes entity object 404 corresponding to an IT solution composite application. Entity object 404 is associated with entity objects 408, 412, and 416, respectively corresponding to an email service, a storage service, and a business applications service. Entity object 408 is associated with characteristic objects 420, 424, and 428, respectively corresponding to the cost, availability, and usability of the email service. Characteristic object 420 is associated with secondary characteristic objects 432 and 436, corresponding respectively to the labor cost and hardware cost portions of the cost of the email service.

In some embodiments, a score of entity object 404 may be calculated. As depicted, entity object 404's score calculation methodology weights and sums the scores of its associated entity objects. Thus, its score is based on the various score calculation methodologies of its associated entity objects 408, 412, and 416. For example, entity object 408's score calculation methodology involves performing a MIN operation on the scores of characteristic objects 420, 424, and 428. Entity object 404's score also depends on the score calculation methodologies of entity objects 412 and 416 (not shown).

Similarly, the score of characteristic object 420 is based on the score calculation methodologies (not shown) of secondary characteristic objects 432 and 436, since the score calculation methodology of characteristic object 420 weights and sums the scores of secondary characteristic objects 432 and 436.

As described, various embodiments of the present disclosure may enable evaluation of composite applications through graphical modeling. Modifications, additions, or omissions may be made to the systems and apparatuses disclosed herein without departing from the scope of the disclosure. The components of the systems and apparatuses may be integrated or separated. For example, one or more objects may be combined and/or the functions of one or more objects may be performed by another object. Moreover, the operations of the systems and apparatuses may be performed by more, fewer, or other components. Additionally, operations of the systems and apparatuses may be performed using any suitable logic comprising software, hardware, and/or other logic. As used in this document, “each” refers to each member of a set or each member of a subset of a set.

Modifications, additions, or omissions may be made to the methods disclosed herein without departing from the scope of the disclosure. The method may include more, fewer, or other steps. Additionally, steps may be performed in any suitable order.

Although this disclosure has been described in terms of certain embodiments, alterations and permutations of the embodiments will be apparent to those skilled in the art. Accordingly, the above description of the embodiments does not constrain this disclosure. Other changes, substitutions, and alterations are possible without departing from the spirit and scope of this disclosure, as defined by the following claims.

What is claimed is:

1. A method comprising:
displaying, by a computing system, one or more characteristic objects that are graphically associated with a first entity object, each characteristic object corresponding to at least one characteristic of an entity corresponding to the first entity object;
receiving an indication of a score calculation methodology of the first entity object and an indication of a score calculation methodology of each characteristic object;
determining, by the computing system, a score of each characteristic object, each score of a respective characteristic object based on at least:
one or more measurements of a measured object that is graphically associated with the first entity object; and
the score calculation methodology of the respective characteristic object; and
determining, by the computing system, a score of the first entity object based on at least:
each score of the one or more characteristic objects; and
the score calculation methodology of the first entity object; and
displaying the score of the first entity object.

2. The method of claim 1, the each score of the respective characteristic object further based on:
a comparison of the one or more measurements of the measured object to one or more values specified by a displayed rating requirement object.

3. The method of claim 1, the receiving the indication of the score calculation methodology of the first entity object comprising:
receiving a weight value for each characteristic object that is graphically associated with the first entity object, each weight value specifying a preference for the characteristic corresponding to the respective characteristic object.

4. The method of claim 1, the determining a score of the first entity object further based on:
an indication of a score calculation methodology of a second entity object that is graphically associated with the first entity object.

5. The method of claim 1, the determining the score of each characteristic object further comprising:
determining the score of a characteristic object of the one or more characteristic objects further based on an indication of a score calculation methodology of one or more secondary characteristic objects that are graphically associated with the characteristic object.

6. The method of claim 1, the determining the score of each characteristic object further comprising:
determining the score of a characteristic object of the one or more characteristic objects further based on a prioritization of a plurality of assessment scores, the assessment scores based on a plurality of measurements of a plurality of measured objects.

7. The method of claim 1, further comprising:
receiving an indication of at least one of:
a modification of the score calculation methodology of the first entity object; and
a modification of the score calculation methodology of at least one of the one or more characteristic objects; and
determining a new score of the first entity object.

8. The method of claim 1, the first entity object selected from a group comprising a composite application object, an information technology service object, a computer system object, and a software component object.

9. One or more tangible non-transitory computer-readable media having computer-executable code, when executed by a computer operable to:
display one or more characteristic objects that are graphically associated with a first entity object, each characteristic object corresponding to at least one characteristic of an entity corresponding to the first entity object;
receive an indication of a score calculation methodology of the first entity object and an indication of a score calculation methodology of each characteristic object;
determine a score of each characteristic object, each score of a respective characteristic object based on at least:
one or more measurements of a measured object that is graphically associated with the first entity object; and
the score calculation methodology of the respective characteristic object; and
determine a score of the first entity object based on at least:
each score of the one or more characteristic objects; and
the score calculation methodology of the first entity object; and
display the score of the first entity object.

10. The media of claim 9, the each score of the respective characteristic object further based on:
a comparison of the one or more measurements of the measured object to one or more values specified by a displayed rating requirement object.

11. The media of claim 9, the receiving the indication of the score calculation methodology of the first entity object comprising:
receiving a weight value for each characteristic object that is graphically associated with the first entity object, each weight value specifying a preference for the characteristic corresponding to the respective characteristic object.

12. The media of claim 9, the determining a score of the first entity object further based on:
an indication of a score calculation methodology of a second entity object that is graphically associated with the first entity object.

13. The media of claim 9, the determining the score of each characteristic object further comprising:
determining the score of a characteristic object of the one or more characteristic objects further based on an indication of a score calculation methodology of one or more secondary characteristic objects that are graphically associated with the characteristic object.

14. The media of claim 9, the determining the score of each characteristic object further comprising:
determining the score of a characteristic object of the one or more characteristic objects further based on a prioritization of a plurality of assessment scores, the assessment scores based on a plurality of measurements of a plurality of measured objects.

15. The media of claim 9, when executed by a computer further operable to:
receive an indication of at least one of:
a modification of the score calculation methodology of the first entity object; and
a modification of the score calculation methodology of at least one of the one or more characteristic objects; and
determine a new score of the first entity object.

16. The media of claim 9, the first entity object selected from a group comprising a composite application object, an information technology service object, a computer system object, and a software component object.

17. An apparatus comprising:
a memory; and
one or more processors coupled to the memory and configured to:
display one or more characteristic objects that are graphically associated with a first entity object, each characteristic object corresponding to at least one characteristic of an entity corresponding to the first entity object;
receive an indication of a score calculation methodology of the first entity object and an indication of a score calculation methodology of each characteristic object;
determine a score of each characteristic object, each score of a respective characteristic object based on at least:
one or more measurements of a measured object that is graphically associated with the first entity object; and
the score calculation methodology of the respective characteristic object; and
determine a score of the first entity object based on at least:
each score of the one or more characteristic objects; and
the score calculation methodology of the first entity object; and
display the score of the first entity object.

18. The apparatus of claim 17, the each score of the respective characteristic object further based on:
a comparison of the one or more measurements of the measured object to one or more values specified by a displayed rating requirement object.

19. The apparatus of claim 17, the receiving the indication of the score calculation methodology of the first entity object comprising:
receiving a weight value for each characteristic object that is graphically associated with the first entity object, each weight value specifying a preference for the characteristic corresponding to the respective characteristic object.

20. The apparatus of claim 17, the determining a score of the first entity object further based on:
an indication of a score calculation methodology of a second entity object that is graphically associated with the first entity object.

21. The apparatus of claim 17, the determining the score of each characteristic object further comprising:
determining the score of a characteristic object of the one or more characteristic objects further based on an indication of a score calculation methodology of one or more secondary characteristic objects that are graphically associated with the characteristic object.

22. The apparatus of claim 17, the determining the score of each characteristic object further comprising:
determining the score of a characteristic object of the one or more characteristic objects further based on a prioritization of a plurality of assessment scores, the assessment scores based on a plurality of measurements of a plurality of measured objects.

23. The apparatus of claim 17, the one or more processors further operable to:
receive an indication of at least one of:
a modification of the score calculation methodology of the first entity object; and
a modification of the score calculation methodology of at least one of the one or more characteristic objects; and
determine a new score of the first entity object.

24. The apparatus of claim 17, the first entity object selected from a group comprising a composite application object, an information technology service object, a computer system object, and a software component object.
